(19) United States
(12) Patent Application Publication
(10) Pub. No.: US 2004/0080299 A1
(43) Pub. Date: Apr. 29, 2004

(54) Energy source recharging device and method

(76) Inventors: Ian J. Forster, Chelmsford (GB); Michael G. Ginn, Chelmsford (GB); Patrick F. King, Glen Ellyn, IL (US)

Correspondence Address: WITHROW & TERRANOVA, P.L.L.C., P.O. BOX 1287, CARY, NC, 27512, US

(21) Appl. No.: 10/422,620

(22) Filed: Apr. 24, 2003

Related U.S. Application Data
(60) Provisional application No. 60/375,247, filed on Apr. 24, 2002.

(51) Int. Cl. H02J 7/00

(52) U.S. Cl. 320/114

(57) ABSTRACT

The invention relates to a wireless communication device that is coupled to a rechargeable energy source, such as a battery or capacitor. The wireless communication device is adapted to receive an energy-bearing signal and recharge the energy source coupled to the wireless communication device. The wireless communication device can use energy from the energy source when not in the field of an interrogation reader, transmitter, or other energy source for communication. If the energy source is above a threshold energy level, the wireless communication device will use the energy-bearing signal to recharge the energy source. The wireless communication device will discontinue recharging of the energy source if the energy source is fully charged. The wireless communication device is capable of using the energy-bearing signal for both receipt of information and recharging of the energy source.

### RELATED APPLICATION

This application claims priority and the benefit of U.S. Provisional Patent Application Serial No. 60/375,247 filed Apr. 24, 2002, which is incorporated by reference herein in its entirety and is related to U.S. patent application Ser. No. ______/______filed on Apr. 24, 2003, entitled “ENERGY SOURCE COMMUNICATION EMPLOYING SLOT ANTENNA” which is also incorporated by reference herein in its entirety.

### FIELD OF THE INVENTION

The present invention is an energy source communication device and method that allows recharging of the energy source through wireless communication.

### BACKGROUND OF THE INVENTION

It is often desired to provide wireless communication for devices. For example, articles of manufacture are often provided wireless communication capability for purposes such as identification, tracking; and manufacturing. A wireless communication device, such as a radio frequency identification device (RFID), is attached to such articles so that the article can wirelessly communicate information during the manufacturing and distribution process.

Another example of a device that has wireless communication capability is an electronic device known as a personal digital assistant (PDA). PDAs are small computing devices that can store electronic information, such as contacts, emails, to-do lists, memos, notes, etc. PDAs are often equipped with a transmitter and receiver to wirelessly communicate with other electronic devices to transfer of information.

Whether a RFID, PDA or other communication device, these devices require power from an energy source to operate. Such energy source is often provided in the form of a battery. Batteries are useful energy sources, because they are commonly available and can be easily replaced when their energy is exhausted. Batteries may also be rechargeable so that replacement of batteries is not required, or required less often.

However, some communication devices are packaged in such a manner that a removable energy source cannot be easily provided. For example, a RFID and its battery may be totally encapsulated in a plastic material. The energy source will eventually run out of energy, and the RFID will have to be replaced. Such replacement will come at an expense of providing and replacing the RFID with a new RFID.

Therefore, a need exists to provide an energy source for a wireless communication device that does not have to be replaced if its energy source runs out of power.

### SUMMARY OF THE INVENTION

The present invention is directed to a wireless communication device that is connected to an energy source. The wireless communication device uses the energy source for power. The wireless communication device is capable of receiving an energy-bearing signal through an antenna. The energy-bearing signal is used by the wireless communication device to recharge the energy source. The energy-bearing signal may also provide energy to the wireless communication device when such energy-bearing signal contains communication information.

In a first embodiment, the wireless communication device contains a switch under control of a control system in the wireless communication device. The wireless communication device rectifies the energy from the incoming energy-bearing signal and passes it to the control system. The control system monitors the energy stored in the energy source and switches energy received from the energy-bearing signal to the energy source for recharging. If the energy source exceeds a threshold energy level or is fully charged, the control system controls the switch to discontinue recharging of the energy source. If the energy-bearing signal received also contains communication information, the control system may switch the energy-bearing signal to both the energy source and the wireless communication device for recharging of the energy source and energizing of the wireless communication device.

In another embodiment, a state machine is executed by a control system in the wireless communication device. The state machine may be programmed in the form of software contained in memory and connected to the control system or the state machine may be in the form of an electronic circuit. The state machine controls the recharging of the energy source and manages the energy from the energy-bearing signal in different modes based on the energy level of the energy source. The state machine also controls the recharging of the energy source when the energy-bearing signal contains communication information.

In another embodiment, a circuit is provided as part of the communications electronics of the wireless communication device. The circuit is designed to receive a high-frequency energy-bearing signal and to control energy from the energy-bearing signal to both power the wireless communication device and the energy source. If the energy source is fully charged, the communication electronics impedance in the wireless communication device is mismatched from the antenna impedance so that the wireless communication device cannot receive the energy-bearing signal.

In another embodiment, a circuit is provided as part of the communications electronics of the wireless communication device to receive a lower frequency energy-bearing signal. If the energy source is fully charged, the communication electronics impedance is mismatched from the antenna impedance so that the wireless communication device cannot receive the energy-bearing signal.

### BRIEF DESCRIPTION OF THE DRAWINGS

FIG. 1 is a schematic diagram of a wireless communication device;

FIG. 2 is a schematic diagram of a wireless energy source recharging system;

FIG. 3 is a schematic diagram of a state machine for a wireless energy source recharging system;

FIG. 4 is a schematic diagram of one embodiment of a wireless communication device used in an energy source recharging system; and

FIG. 5 is a schematic diagram of an alternative embodiment of a wireless communication device used in an energy source recharging system that has a dependence upon frequency of an incoming signal.

### DETAILED DESCRIPTION OF THE INVENTION

The present invention is directed to a device, system and method of recharging an energy source that is used to power a wireless communication device. The wireless communication device is capable of recharging the energy source when the wireless communication device receives an energy-bearing signal, such as a radio-frequency signal.

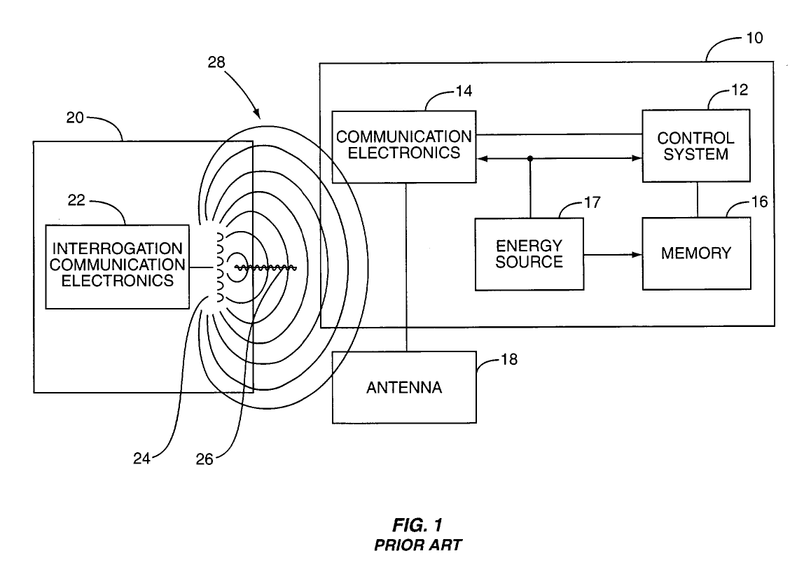

Referring now to the drawings in general, and to FIG. 1 in particular, it will be understood that the illustrations are for the purpose of describing specific embodiments of the present invention and are not intended to limit the invention thereto.

FIG. 1 illustrates a typical wireless communication device 10 and communication system in the prior art. The wireless communication device 10 is capable of communicating information wirelessly and may include a control system 12, communication electronics 14, memory 16, and energy source 17. The wireless communication device 10 may be a radio-frequency identification device (RFID), but the present invention is not limited to any particular type of wireless communication device 10. The communication electronics 14 is coupled to an antenna 18 for receiving and communicating information in the form of radio-frequency signals. The communication electronics 14 is capable of receiving a modulated radio-frequency signal through the antenna 18 and demodulating the signal into information passed to the control system 12. The antenna 18 may be internal or external to the wireless communication device 10, and may be any type of antenna including a pole antenna or slot antenna.

The control system 12 may be any type of circuitry or processor that receives and processes information received by the communication electronics 14, such as a micro-controller or microprocessor. The wireless communication device 10 may also contain a memory 16 for storage of information. Such information may be any type of information including identification, tracking and other communication information. The memory 16 may also store software containing operating instructions carried out by the control system 12. The memory 16 may be electronic memory, such as random access memory (RAM), read-only memory (ROM), flash memory, diode, etc., or the memory 16 may be mechanical memory, such as a switch, dip-switch, etc.

The energy source 17 may be any type of energy source to provide energy to the components of the wireless communication device 10, including but not limited to a battery, capacitor, and solar cell.

Some wireless communication devices 10 are termed “active” devices meaning that they both receive and transmit data using an energy source 17 coupled to the wireless communication device 10. A wireless communication device 10 may use a battery for the energy source 17 as described in U.S. Pat. No. 6,130,602 entitled “Radio frequency data communications device,” or may use other forms of energy and/or power, such as a capacitor as described in U.S. Pat. No. 5,833,603, entitled “Implantable biosensing transponder.” Both of the preceding patents are incorporated herein by reference in their entirety.

Other wireless communication devices 10 are termed “passive” devices meaning that they do not actively transmit and therefore may not need their own energy source 17 for energy. One type of passive wireless communication device 10 is known as a “transponder.” A transponder effectively transmits information by reflecting back a received signal from an external communication device, such as an interrogation reader 20. An example of a transponder is disclosed in U.S. Pat. No. 5,347,280, entitled “Frequency diversity transponder arrangement,” incorporated herein by reference in its entirety. Another example of a transponder is described in co-pending patent application Ser. No. 09/678,271, entitled “Wireless Communication Device and Method,” incorporated herein by reference in its entirety.

FIG. 1 depicts communication between a wireless communication device 10 and the interrogation reader 20. The interrogation reader 20 includes an interrogation communication electronics 22 and an interrogation antenna 24. The interrogation reader 20 communicates with the wireless communication device 10 by emitting an electronic signal 26 modulated by the interrogation communication electronics 22 through the interrogation antenna 24. The interrogation antenna 24 may be any type of antenna that can radiate a signal 26 through a field 28 so that a reception device, such as a wireless communication device 10, can receive such signal 26 through its own antenna 18. The field 28 may be electromagnetic, magnetic, or electric. The signal 26 may be a message containing information and/or a specific request for the wireless communication device 10 to perform a task.

When the antenna 18 is in the presence of the field 28 emitted by the interrogation reader 20, the communication electronics 14 are energized by the power in the field 28, thereby energizing the wireless communication device 10. The wireless communication device 10 remains energized so long as the antenna 18 is in the field 28. The communication electronics 14 demodulates the signal 26 and sends the message containing information and/or a specific request to the control system 12 for appropriate actions. It is readily understood to one of ordinary skill in the art that there are many other types of wireless communications devices and communication techniques than those described herein, and the present invention is not limited to a particular type of wireless communication device 10, technique or method.

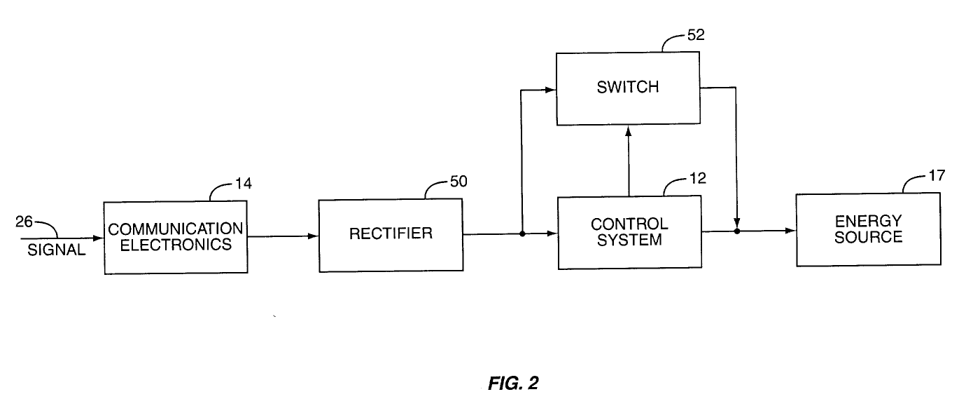

FIGS. 2-5 illustrate various aspects of the present invention. The wireless communication device 10 uses an energy-bearing radio-frequency signal 26 to recharge the energy source 17. The energy-bearing signal 26 is received through the antenna 18. Typical recharging systems recharge the energy source 17 by directly coupling a device containing the energy source 17 to an external power source, such as a power outlet. More information on a typical recharging system is disclosed in U.S. Pat. No. 6,191,552, entitled “External universal battery charging apparatus and method,” incorporated herein by reference in its entirety. However, the present invention does not require direct coupling of the energy source 17 to a power supply.

External radio-frequency signals 26 received by the wireless communication device 10 may contain energy. Since the wireless communication device 10 is capable of receiving energy from an energy-bearing radio frequency signal 26 through its antenna 18, the wireless communication device 10 may recharge the energy source 17 using such energy-bearing radio-frequency signal 26 rather than directly connecting the wireless communication device 10 to a power source. The energy-bearing radio-frequency signal 26 may be generated by an interrogation reader 20 located nearby the wireless communication device 10, or from a remote radio-frequency transmitter. The wireless communication device 10 uses the energy in the energy-bearing radio-frequency signal 26 to recharge the energy source 17.

FIG. 2 illustrates a block diagram of one embodiment of a recharging system. The communication electronics 14 receives an incoming energy-bearing radio-frequency signal 26. The signal 26 is demodulated by the communication electronics 14 and rectified by the rectifier 50 to produce a DC voltage signal. This DC voltage signal may be used to charge the energy source 17. The control system 12 opens and closes a switch 52 to control the recharging of the energy source 17. The control system 12 closes the switch 52 to recharge the energy source 17 so that DC voltage produced from the incoming, rectified signal from the rectifier 50 is connected to the energy source 17. The control system 12 opens the switch 52 if it is not desired to recharge the energy source 17. The control system 12 decides whether or not to recharge the energy source 17 based on its specific design or programming.

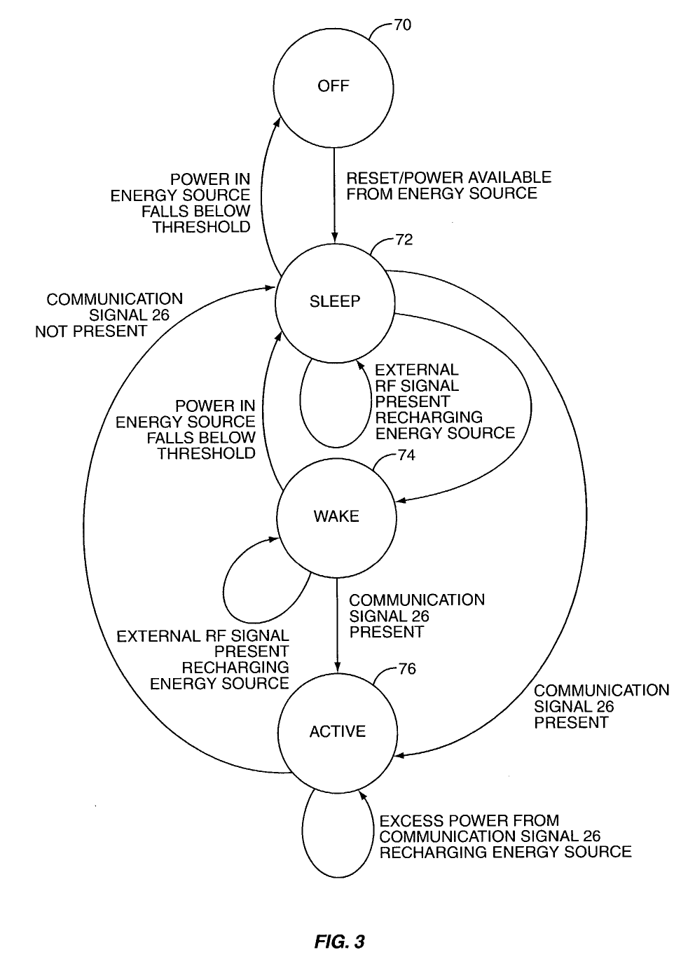

FIG. 3 illustrates a state diagram that may be used with the control system 12 to manage recharging of the energy source 17. The control system 12 may use circuitry or software contained in the memory 16 to execute this state machine. The first state in the state machine is the OFF state (state 70). The wireless communication device 10 is initially in the OFF state at initialization after manufacturing or if the energy source 17 is no longer rechargeable. Once the wireless communication device 10 is reset or energy is available from the energy source 17 sufficient for the wireless communication device 10 to operate, the control system 12 transitions to the SLEEP state (state 72).

The wireless communication device 10 consumes minimal power from the energy source 17 in SLEEP state, but the control system 12 is able to detect an incoming signal 26 from an interrogation reader 20 or other communication device and is capable of making decisions about the energy source 17 based on criteria such as voltage, time, and other data criteria. Minimal power may be around about 10 microWatts or less for example. Additionally, the control system 12 allows the energy source 17 to be recharged if the wireless communication device 10 is in the presence of an energy-bearing radio-frequency signal 26. The control system 12 may also use the energy-bearing radio-frequency signal 26 for power of the wireless communication device 10 or for recharging of the energy source 17.

The control system 12 transitions from the SLEEP state back to the OFF state if the energy in the energy source 17 falls below a threshold energy level necessary for the control system 12 to operate or is totally drained of energy. If the control system 12 detects that the energy source 17 is above a certain threshold energy level, such as 2.0 Volts for example, the control system 12 transitions from the SLEEP state to the WAKE state (state 74). If the control system 12 receives communications from the interrogation reader 20 or other communication device, the control system 12 transitions to the ACTIVE state (state 76).

The wireless communication device 10 is capable of receiving the energy-bearing signal 26 in the WAKE state. The wireless communication device 10 is also capable of making decisions about the energy source 17 and its utilization based on voltage, time and other data criteria. Medium power is consumed from the energy source 17 so that the wireless communication device 10 can respond to any communication received by the communication electronics 14. Medium power may be around about 10 milliwatts—500 milliWatts for example. The control system 12 also uses the received energy-bearing radio-frequency signal 26 to recharge the energy source 17 and/or to power the wireless communication device 10. If the control system 12 detects power in the energy source 17 below a certain threshold value, the control system 12 transitions back to the SLEEP state (state 72). If the control system 12 receives a communication signal 26 from an interrogation reader 20 or other communication device, the control system 12 transitions from the WAKE state to the ACTIVE state (state 76).

In the ACTIVE state, the wireless communication device 10 is capable of making decisions about the energy source 17 and its utilization based on voltage, time and other data criteria. Medium power is consumed just as in the WAKE state. The wireless communication device 10 remains in the ACTIVE state so long as a signal 26 is present. If the signal 26 is of a sufficiently high voltage, such that excess energy still exists even when the signal 26 is used to provide power to the wireless communication device 10, the excess energy is controlled by the control system 12 to recharge the energy source 17. If excess energy is not present in the signal 26, the wireless communication device 10 uses the energy to power the wireless communication device 10 only. Once the signal 26 is no longer detected by the wireless communication device 10, the wireless communication device 10 transitions to the SLEEP state. Once in SLEEP state, the control system 12 immediately transitions into the WAKE state if energy source 17 is above a threshold energy level, as previously discussed.

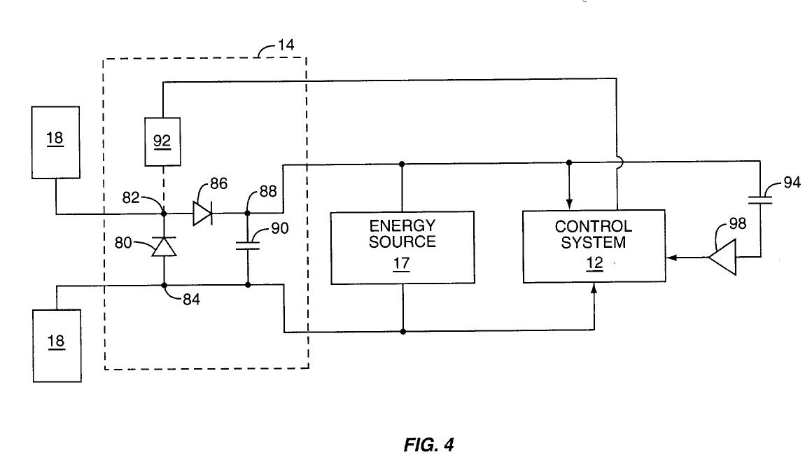

FIG. 4 illustrates another embodiment of the communication electronics 14 for recharging an energy source 17. This embodiment may be used in conjunction with the state diagram in FIG. 3 to manage the energy source 17 for the wireless communication device 10. In this embodiment, the communications electronics 14 is a modulation and voltage-limiting device. A first diode 80 is connected in parallel with the antenna 18 at node one 82 and at node two 84. A second diode 86 is connected in series to node one 82 and to node three 88. A capacitor 90 is connected in parallel to node three 88 and to node two 84, which is the output of the communication electronics 14. An inductor 92 is connected between node one 82 and the control system 12. The energy source 17 is connected in parallel to node three 88 and to node two 84 to receive energy for recharging. A coupling capacitor 94 and buffer 98 are coupled between the communication electronics 14 and the control system 12 to block any direct current (DC) in the data sent from reaching the communications electronics 14.

When the communications electronics 14 enters into the field 28 at a distance where the voltage of the signal 26 received by the communication electronics 14 is below the energy source 17 voltage, the control system 12 is activated to communicate with the interrogation reader 20 by detecting the incoming modulation of the signal 26 and responding by reflecting the energy back to the interrogation reader 20. As the wireless communication device 10 comes into close contact with the field 28, the output voltage from the communication electronics 14 increases and begins to pass energy to the energy source 17. The control system 12 monitors the voltage of the energy source 17. If the energy in the energy source 17 exceeds a threshold energy or indicates a full charge, the control system 12 drives the modulation signal 26 to intentionally mismatch the impedance of the communication electronics 14 from the antenna 18 to prevent the wireless communications device 10 from absorbing more energy and overcharging the energy source 17.

If the wireless communication device 10 is receiving an energy-bearing radio-frequency signal 26 that is not from an interrogation reader 20 or is a communication signal 26, the energy source 17 may still be charged. The control system 12 will still continue to monitor the energy source 17 voltage to ensure that the energy source 17 is not overcharged as previously discussed above.

It may be desired to allow a signal 26 encoded with a clock signal to be communicated to the control system 12 and to recharge the energy source 17. For example, the signal 26 could be encoded with a Manchester bi-phase data stream at 50 Kilobytes/second. A separate communication electronics 14 may be coupled to the antenna 18 to receive the modulated signal 26 encoded with a clock signal. However, another approach is to introduce a frequency dependent impedance into the communication electronics 14.

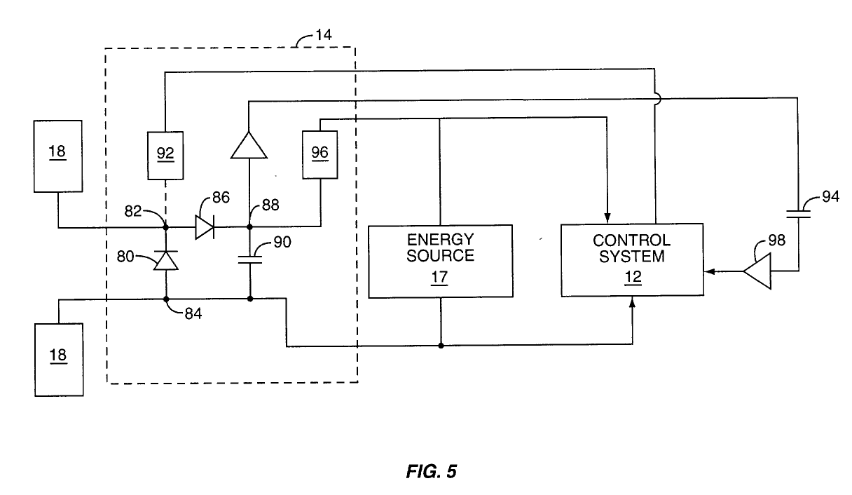

FIG. 5 illustrates the introduction of a frequency dependent impedance into the communication electronics 14. This embodiment is essentially the same as illustrated in FIG. 4; however, an additional inductor 96 is connected between node three 88 and the energy source 17. DC is used to power the wireless communication device 10 and to recharge the energy source 17. DC also passes with low resistance through the inductor 96, but the value of the inductor 96 is chosen to present a comparatively high impedance at a desired signal 26 frequency. In one aspect, the inductor 96 is chosen so that the communication electronics 14 resonates at a particular frequency in which the inductor 96 will act as a high impedance. When the inductor 96 acts as a high impedance, the inductor 96 will not allow DC from the incoming signal 26 to recharge the energy source 17. If the communication electronics 14 does not resonate, the capacitor 90 is effectively in parallel with the energy source 17 thereby allowing DC from the incoming signal 26 to recharge the energy source 17. Thus, the choice of the inductor 96 affects the resonance of the communication electronics 14. The frequency of the incoming signal 26 may be controlled to either allow or disallow recharging of the energy source 17 based the quality factor, or Q, of the communication electronics 14.

It may also be desired to recharge the energy source 17 with a low-frequency signal 26, for example 125 KHz. If the communication electronics 14 is placed in a magnetic field 28 that is oscillating with a frequency matched to the resonance of the communication electronics 14 and/or its components, such as the capacitor 90 and the inductor 96, the communication electronics 14 may rectify the induced voltage across the impedance 96 to produce a DC voltage to charge the energy source 17. Therefore, the energy source 17 may be charged using a signal 26 of a lower frequency. Adaptation of the wireless communication device 10 to recharge the energy source 17 at a lower frequency may be less expensive since low frequency transmission devices are typically less expensive than high frequency transmission devices.

In another aspect of the present invention, a gap or slot between battery terminals is used to form a slot antenna 18. The slot antenna 18 receives the energy-bearing signal 26 or communication signal 26 and is used by wireless communication device 10 to recharge the energy source 17 as previously described. A slot antenna 18 radiation pattern will be similar to a pole antenna radiation pattern, but the E and H fields will be reversed from a similar pole antenna. A complete disclosure on slot antennas 18 using a slot provided on an energy source is described in Provisional Application No. 60/375,258 entitled “Energy source communication employing slot antenna,” filed on the same day as the present provisional application and incorporated hereby by reference in its entirety, and enclosed as an Appendix hereto.

Certain modifications and improvements will occur to those skilled in the art upon a reading of the foregoing description. It should be understood that the present invention is not limited to, any particular type of component including, but not limited to the wireless communication device 10 and its components, interrogation reader 20 and its components, control system 12, communication electronics 14, memory 16, energy source 17, antenna 18, state machine, software, and other circuitry. Power and energy may be used interchangeably with the present invention, and the present invention is not limited to only power or energy in any embodiment if only one of these terms is used. For the purposes of this application, couple, coupled, or coupling is defined as either a direct connection or a reactive coupling. Reactive coupling is defined as either capacitive or inductive coupling.

One of ordinary skill in the art will recognize that there are different manners in which these elements can provide to accomplish the present invention. The present invention is intended to cover what is claimed and any equivalents. The specific embodiments used herein are to aid in the understanding of the present invention, and should not be used to limit the scope of the invention in a manner narrower than the claims and their equivalents.

What is claimed is:

1. A rechargeable energy device, comprising:
an energy source;
a wireless communication device attached to said energy source and adapted to receive an energy-bearing signal; and
said wireless communication device adapted to recharge said energy source when said energy source exceeds a threshold energy level.

2. The device of claim 1, wherein said energy source contains a separator to form a slot and wherein said wireless communication device is coupled to said slot to form a slot antenna for receiving said energy-bearing signal.

3. The device of claim 1, wherein said wireless communication device further comprises a control system to control said energy-bearing signal for energy to said wireless communication device to recharge said energy source.

4. The device of claim 1, wherein said wireless communication device directs said energy-bearing signal to power said wireless communication device and to recharge said energy source.

5. The device of claim 1, wherein said wireless communication device further comprises a communication electronics that receives said energy-bearing signal and limits the voltage of said energy-bearing signal directed to said energy source.

6. The device of claim 3, wherein said control system monitors said energy source to determine if said energy source is fully charged.

7. The device of claim 3, wherein said wireless communication device further comprises a communication electronics that receives said energy-bearing signal and wherein said control system mismatches the impedance of said communication electronics if the voltage of the energy source exceeds a threshold energy level.

8. The device of claim 1, wherein said wireless communication device is adapted to receive a high frequency energy-bearing signal to recharge said energy source.

9. The device of claim 8, wherein said wireless communication device further comprises
a control system connected to said energy source;
a first node coupled to said antenna;
a second node coupled to said antenna;
a first diode connected to said first node and said second node;
a second diode connected to said first node and a third node;
a capacitor connected to said third node and said first node;
said control system and the energy source connected to said second node;
an impedance connected to said first node and said control system; and
said third node connected to said control system.

10. The device of claim 8, wherein said high frequency is comprised from the group consisting of around about 915 MHz and around about 2.45 GHz.

11. The device of claim 1, wherein said wireless communication device is adapted to receive a low frequency energy-bearing signal to recharge said energy source.

12. The device of claim 11, wherein said wireless communication device further comprises
a control system connected to said energy source;
a first node coupled to said antenna;
a second node coupled to said antenna;
a first diode connected to said first node and said second node;
a second diode connected to said first node and a third node;
a capacitor connected to said third node and said first node;
said control system and the energy source connected to said second node;
an impedance connected to said first node and said control system;
said third node connected to said control system; and
an inductor connected to said third node and said control system to form a frequency dependant circuit.

13. The rechargeable energy source of claim 12, wherein said low frequency is around about 125 KHz.

14. The device of claim 3, wherein said control system further comprises a state machine to control the recharging of said energy source.

15. The device of claim 14, wherein said state machine comprises an off state wherein said energy source is below a threshold energy level.

16. The device of claim 14, wherein said state machine transitions to a sleep state wherein said wireless communication device consumes minimal energy.

17. The device of claim 16, wherein said control system transitions to said sleep state when said energy source falls below a threshold energy level.

18. The device of claim 14, wherein said state machine comprises a wake state wherein said wireless communication device consumes medium power.

19. The device of claim 18, wherein said control system transitions to said wake state when said energy source exceeds a threshold energy level.

20. The device of claim 14, wherein said state machine further comprises an active state wherein said wireless communication device consumes medium power and communicates information wirelessly.

21. The device of claim 20, wherein said control system transitions to said active state when said wireless communication device detects a communication signal.

22. The device of claim 3, wherein said control system executes a software on a memory coupled to said control system to control the recharging of said energy source.

23. A rechargeable energy device, comprising:
an energy source;
a wireless communication device attached to said energy source and adapted to receive information through a communication signal; and
said wireless communication device adapted to recharge said energy source using said communication signal if said communication signal exceeds a threshold energy level.

24. A rechargeable energy device, comprising:
an energy source;
a wireless communication device attached to said energy source;
said wireless communication device containing a communication electronics coupled to an antenna for receiving an energy-bearing signal for recharging said energy source; and
said communication electronics adapted to mismatch its impedance from said antenna if said energy source is fully charged.

25. A wireless communication energy source recharging system, comprising:
an energy source;
a wireless communication device attached to said energy source;
a transmitter adapted to transmit an energy-bearing signal wirelessly to said wireless communication device; and
said wireless communication device adapted to receive an energy-bearing signal and recharge said energy source if said energy-bearing signal is above a threshold voltage.

26. The system of claim 25, wherein said energy-bearing signal is also a communication signal.

27. The system of claim 25, wherein said wireless communication device communicates information back to said transmitter by reflecting said energy-bearing signal to said transmitter.

28. The system of claim 26, wherein said wireless communication device only uses said communication signal for information if said energy source is fully charged.

29. The system of claim 26, wherein said communication signal contains information comprised from the group consisting of identification information, tracking information, and manufacturing information.

30. The device of claim 25, wherein said energy-bearing signal contains a clock signal.

31. The system of claim 30, wherein said clock signal is a Manchester data stream.

32. A method of recharging an energy source coupled to a wireless communication device, comprising the steps of:
placing the wireless communication device in range of an energy-bearing signal;
receiving said energy-bearing signal; and
recharging the energy source with said energy-bearing signal.

33. The method of claim 32, wherein said charging is performed only when the energy of said energy source is below a threshold level.

34. The method of claim 32, wherein said charging is discontinued if said energy source is charged above a threshold level.

35. The method of claim 32, further comprising discontinuing recharging if said energy source is fully charged.

36. The method of claim 35, wherein said discontinuing further comprises mismatching the frequency response of the wireless communication device from said energy-bearing signal.

37. The method of claim 32, wherein said recharging further comprises switching said energy-bearing signal to said energy source.

38. The method of claim 35, wherein said discontinuing further comprises switching said energy-bearing signal away from said energy source.

39 The method of claim 32, further comprising entering into an active state when a communication signal is detected by the wireless communication device.

40. The method of claim 39, further comprising powering the wireless communication device and recharging said energy source from said communication signal.

41. The method of claim 39, further comprising discontinuing said recharging if said communication signal is below a threshold energy level.

42. The method of claim 32, further comprising regulating energy consumption of said energy source by the wireless communication device.
